(19) United States
(12) Patent Application Publication
(10) Pub. No.: US 2024/0381502 A1
(43) Pub. Date: Nov. 14, 2024

(54) MICROWAVE HEATING SYSTEMS

(71) Applicant: Yehuda Zirkin, Staten Island, NY (US)

(72) Inventor: Yehuda Zirkin, Staten Island, NY (US)

(21) Appl. No.: 18/314,429

(22) Filed: May 9, 2023

(51) Int. Cl. H05B 6/80

(52) U.S. Cl. CPC H05B 6/804

(57) ABSTRACT

A heating system includes: a microwave generator; a medium reservoir chamber; a radiator; and a channel that fluidically connects the medium reservoir chamber and the radiator. The radiator includes hollow fins extending from and in fluidic communication with the channel. A medium extends as a single fluid body within a combination of the medium reservoir chamber and the channel. The microwave generator is configured to generate microwaves directed into the medium reservoir chamber so that the microwaves impinge upon internal surfaces of the medium reservoir chamber to thereby impinge upon the medium within the medium reservoir chamber, causing the medium to be heated, the heating of the medium generating a hot vapor in the channel, which rises from the channel into the fins, the fins thereby being heated for radiation of heat into an external environment.

### FIELD OF THE INVENTION

The present invention relates to highly efficient ambient and water heating systems that generate heat using microwaves.

### BACKGROUND

Ambient heaters are well-known. Such heaters include space heaters and radiators, which operate using electrical power from a power source.

Water heaters are also conventionally known. Typically water heaters have a heating source, e.g., a boiler, that uses fire to heat water that is contained within piping that coils in a tank housing the water to be heated. The coils, which are heated by the hot water flowing therethrough, transfer heat to the water in the water tank, thereby heating the water.

### SUMMARY

Example embodiments of the present invention are directed to an improved ambient air heating system that is significantly more efficient than conventional ambient heaters. For example, the heating systems of the present invention are able to produce the same amount or even more heat than the conventional heaters using significantly less electricity. For example, while a conventional heater uses approximately 1,500 watts of power at 120 volts to generate heat, example embodiments of the present invention produce the same amount of heat using 700-900 watts of power at 120 volts.

As noted above, typical water heaters use water running through piping that coils within the water tank as a medium by which to heat the coiling pipes, for transfer of heat to heat the water in the tank. Although oil can be heated more quickly and efficiently than water, oil is not conventionally used within the coiling piping for heating the water in the water tank. One reason for this is a danger caused by heating the oil using fire or the like. Additionally, the use of fire or another conventional heating source for heating the water in the coiled piping is inefficient. In contrast to the conventional system, according to an example embodiment of the present invention, oil flows through the oiling piping and is heated by a medium which is, in turn, heated by microwaves, the coiled piping having the oil therein heating the water in the water tank of the water heater. Such a system is more efficient than the conventional heating system, where increased efficiency is due to the lower power needed by using microwaves and also due to use of oil in the coiled piping.

Further advantages of the embodiments of the present invention include removal of risk of exposure to exposed wires and removal of a requirement for a gas furnace.

According to an example embodiment of the present invention, a heating system includes: a microwave generator, a medium reservoir chamber, a radiator, and a channel that fluidically connects the medium reservoir chamber and the radiator. The radiator includes hollow fins extending from and in fluidic communication with the channel. A medium extends as a single fluid body within a combination of the medium reservoir chamber and the channel. The microwave generator is configured to generate microwaves and direct the microwaves into the medium reservoir chamber so that the microwaves impinge upon one or more internal surfaces of the medium reservoir chamber, the microwaves thereby reflecting off of the one or more internal surfaces to thereby impinge upon a portion of the medium that is within the medium reservoir chamber, causing the medium to be heated. The heating of the medium generates a hot vapor in the channel, which rises from the channel into the fins, the fins thereby being heated. By the heating of the fins, the fins are configured to radiate heat into an external environment.

In an example, the microwave generator includes a magnetron that generates the microwaves. In an example, the microwave generator further includes a transformer and a capacitor arranged to power the magnetron. In an example, the microwave generator further includes a power source from which the transformer draws electrical energy. In an example, the microwave generator further includes a cooling structure arranged to cool the magnetron. In an example, the cooling structure is a fan.

In an example, the medium is oil. In an example, the oil is specifically lavender oil. In an example, the medium fills the medium reservoir chamber only until a height point of the medium reservoir chamber that is lower than a region of the medium reservoir chamber at which the microwaves generated by the microwave generator enter the medium reservoir chamber. For example, in an example embodiment, the medium reaches a height of approximately three inches of the medium reservoir chamber. In an example, a top surface of the medium in the medium reservoir chamber is exposed to a remainder of an interior of the medium reservoir chamber that is above the top surface of the medium in the medium reservoir chamber.

In an example, the medium reservoir chamber is horizontally arranged, by which a height of the medium reservoir chamber is less than a length of the medium reservoir chamber, the length being in a direction in which the channel extends across the fins. In an example, the height of the medium reservoir chamber is also less than a width of the medium reservoir chamber.

In an example, the medium reservoir chamber is horizontally arranged, by which a height of the medium reservoir chamber is less than a width of the medium reservoir chamber, the width being in a direction that is perpendicular to a direction in which the channel extends across the fins.

In an example, the heating system further includes a one-way film or filter that prevents the microwaves that have entered the medium reservoir chamber from the microwave chamber from exiting the medium reservoir chamber in a direction towards the microwave generator.

According to an example embodiment of the present invention, a heating system includes: a microwave generator, a medium reservoir chamber, a piping system that extends into and out of the medium reservoir chamber and a part of which winds within the medium reservoir chamber, thereby forming coils within the medium reservoir chamber, and a hot air blower. During operation of the heating system, the microwave generator is configured to generate microwaves and direct the microwaves into the medium reservoir chamber so that the microwaves heat a medium stored in the medium reservoir chamber. A refrigerant flows within the piping, entering, within the piping, at a first temperature into an interior of the medium reservoir chamber. After entering into the medium reservoir chamber, the refrigerant is heated by the heated medium to a second temperature that is higher than the first temperature, while the refrigerant is in the coils. The refrigerant, which has been heated to the first higher temperature, is directed via the piping from the medium reservoir chamber towards a hot air blower that outputs hot air into an environment external to the heating system using the heating of the refrigerant.

In an example, the heating system further includes an expansion valve and an evaporator via which the heated refrigerant is cooled down to the first temperature, where, during the operation of the heating system, the refrigerant flows within the piping from the expansion valve and evaporator into the medium reservoir chamber.

In an example, the heating system further includes a compressor arranged between the medium reservoir chamber and the hot air blower, where, during the operation of the heating system, the compressor is configured to further heat the refrigerant exiting from the medium reservoir chamber at the second temperature to a third temperature that is higher than the second temperature, the hot air blower being arranged to use the refrigerant at the third temperature to blow the hot air.

In an example, the hot air blower is part of a condenser. In an example, the condenser includes a condenser coil and a fan.

According to an example embodiment of the present invention, a water heating system includes: a water tank, a cold water inlet, a hot water outlet, a medium reservoir chamber, a microwave generator, a flow pump, and a piping system that extends from the medium reservoir chamber into the water tank, winds within the water tank thereby forming coils within the water tank, and further extends from the water tank back to the medium reservoir chamber. During operation of the heating system, the microwave generator is configured to generate microwaves directed into the medium reservoir chamber by which a medium within the piping is heated. The flow pump is configured to cause the heated medium to flow from the medium reservoir chamber into the coils, the medium cycling back from the coils to the medium reservoir chamber. The flow of the heated medium into the coils heats the coils, by which the coils transfer heat to cold water that has been input into the water tank via the cold water inlet. The water that has been heated by the coils can be drawn from the water tank via the hot water outlet.

In an example, the medium in the piping is oil.

In an example, the heating of the medium occurs due to impingement of the microwaves upon a portion of the medium that is exposed to the microwaves in the medium reservoir chamber. In an alternative example, the heating of the medium occurs due to impingement of the microwaves upon another medium sealed within the medium reservoir chamber, thereby heating the other medium, the heated other medium thereby heating a portion of the medium in the piping that is within a section of the piping that is within the medium reservoir chamber.

### BRIEF DESCRIPTION OF THE DRAWINGS

FIG. 1 illustrates a microwave radiator heating system according to an example embodiment of the present invention.

FIG. 2 illustrates a microwave heating system using a refrigerant and condenser, according to an example embodiment of the present invention.

FIG. 3 illustrates a microwave water heating tank according to an example embodiment of the present invention.

### DETAILED DESCRIPTION

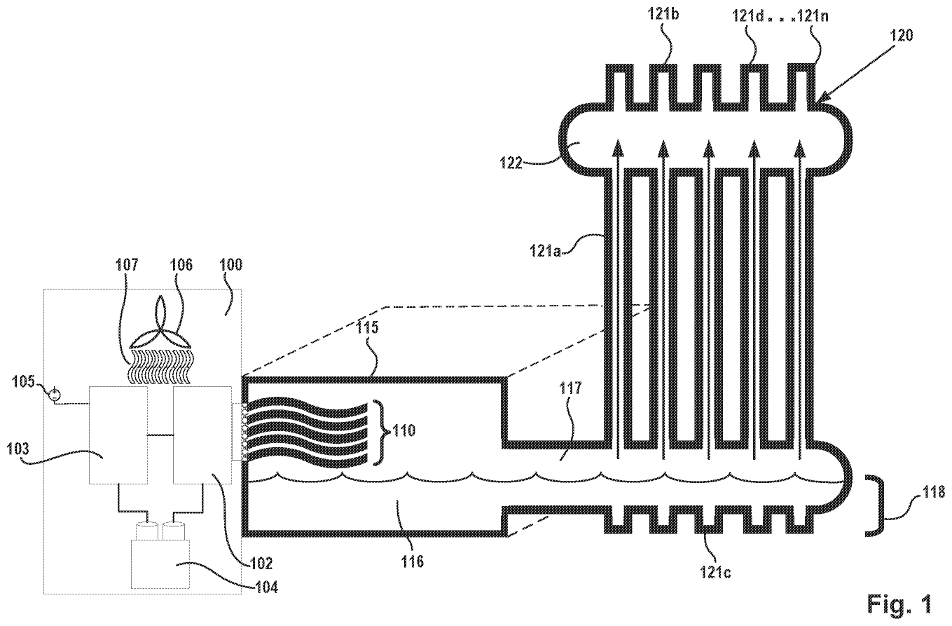

FIG. 1 illustrates a microwave radiator heating system according to an example embodiment of the present invention. The microwave radiator heating system includes a microwave generator 100 configured to generate electromagnetic radiation in the form of microwaves 110. The system further includes a reservoir chamber 115, a radiator 120, and a channel 117 fluidically connecting the reservoir chamber 115 and the radiator 120. In an example embodiment, as shown in FIG. 1, the radiator 120 includes radiator fins 121a-121n. Although FIG. 1 shows five fins 121a-121n, this is by way of example only, and there can instead be a greater number of fins or fewer fins. The channel 117 provides a fluidic connection between the fins 121a-121n. In the illustrated example, the radiator 120 further includes a vapor chamber 122 that provides a further fluidic connection between the fins 121a-121n. In an alternative example embodiment, each of the fins 121a-121n is provided a respective vapor chamber 122 not fluidically connected to the respective vapor chambers 122 of the other fins 121a-121n. In an alternative example embodiment, the fins 121a-121n are not provided with a vapor chamber 122. However, the vapor chamber(s) 122 is preferable for increasing a heat radiating surface area.

In the illustrated example embodiment, the fins 121a-121n are shown to be structured relative to the channel 117 and the vapor chamber 122 so that they extend, not only between the channel 117 to the vapor chamber 122, but also further extend above the vapor chamber 122 and below the channel 117. According to alternative example embodiments, the fins 121a-121n do not extend above the vapor chamber 122, for example with the top of the vapor chamber 122 being the top of the radiator 120, and/or the fins 121a-121n do not extend below the channel 117, for example with the bottom of the channel 117 being the bottom of the radiator 120.

The reservoir chamber 115 is at least partly filled with a medium 116 to be heated. In a preferred example embodiment, the medium 116 is oil. More specifically, the inventor has discovered that lavender oil is particularly suited for efficient heating in the embodiments of the present invention, using the microwaves 110 for heating the medium 116, the thin molecules of the lavender oil vibrating particularly well under influence of the microwaves 110. The medium 116 preferably does not fill the entire reservoir chamber 115. Preferably, the medium 116 is provided so that it does not reach half the height of the reservoir chamber 115. In a preferred example embodiment, the medium 116 fills up to a height 118 of the reservoir chamber 115 of approximately three inches, with the bottom interior surface of the channel 117 being at a height that is lower than the uppermost point of the medium 116 in the reservoir chamber 115, so that that the medium 116 flows between the reservoir chamber 115 and the channel 117 across the fins 121a-121n. In an example embodiment of the present invention, approximately 1 to 1.5 liters of the medium 116 in included in the reservoir chamber 115 and the channel 117.

In a preferred example embodiment, the reservoir chamber 115 is made of copper.

The microwave generator 100 is configured to generate microwaves 110 directed into the reservoir chamber 115, so that the microwaves 110 heat the medium 116 included in the reservoir chamber 115 and therefore, by extension, in the channel 117. In a preferred example embodiment, the microwave generator 100 is arranged relative to the reservoir chamber 115 so that the microwaves 110 initially enter into the reservoir chamber 115 above the top surface of the medium 116. The microwaves 110 are reflected against one or more interior surfaces of the reservoir chamber 115 so that they efficiently impinge upon the medium 116, thereby heating the medium 116. In a particularly preferred example embodiment, by which the inventor has discovered a particularly efficient heating of the medium 116, the reservoir chamber 115 is arranged horizontally, where the height of the reservoir chamber 115 is less than the length of the reservoir chamber 115 in at least one of the other two directions, preferably less than the lengths of the reservoir chamber 115 in both of the other two directions as is illustrated by the broken lines showing an example three-dimensional structure of the reservoir chamber 115. (It is noted that the other components illustrated in FIG. 1 are shown in a two-dimensional perspective and no deduction can be made from FIG. 1 regarding the depth positioning or size of the other illustrated components.) In a particularly preferred example embodiment, the interior of the reservoir chamber 115 includes curved surfaces for better reflection of the microwaves 110.

In an example, the heating of the medium 116 generates vapor which rises within the fins 121a-121n as represented by the arrows shown in the fins 121a-121n, thereby filling the fins 121a-121n and the vapor chamber 122 with hot vapor, radiated into the ambient environment by the material of the outer shell of the radiator 120, which is for example a metal such as steel, aluminum, copper, and/or iron.

In an example embodiment, the reservoir chamber 115 includes a bore via which the microwaves 110 generated by the microwave generator 100 enter into the reservoir chamber 115, with a microwave output of the microwave generator 100 being positioned at, and directed with a waveguide towards, the bore. In an example embodiment, the system further includes a one-way film 112 arranged in or at the bore, so that the microwaves 110 that enter into the reservoir chamber 115 do not exit the reservoir chamber 115 in a reverse direction, back through the bore towards the microwave generator 100.

In an example, as shown in FIG. 1, the microwave generator 100 includes a magnetron 102 that generates the microwaves, a transformer 103 and a capacitor 104 for powering the magnetron 102, and a power source 105 as an electrical power source supplying a voltage to the transformer 103 and the capacitor 104. For example, in an example embodiment the system includes a plug that can be plugged into a wall outlet, in response to which the voltage is provided, powering up the system. In an alternative example embodiment, a further manually operated on/off switch is additionally provided, so that powering up occurs only if both the plug is plugged into the outlet and the on/off switch is set to the on position. In an example, the transformer 103 transforms the supplied voltage by increasing the power level, since a typical voltage supplied by power source 105 is insufficient for operation of the magnetron 102. The capacitor 104 can ensure a steady power flow for the magnetron 102 during the course of charge and discharge cycles. As shown in FIG. 1, in an example embodiment, the electrical circuitry is provided so that the power source 105 is connected to the transformer 103, with wired connections of the transformer 103 to the magnetron 102 and to the capacitor 104, and with a wired connection of the capacitor 104 to the magnetron 102.

In an example embodiment of the present invention, the microwave generator 100 further includes a cooling system for cooling the magnetron 102 and/or the transformer 103, which can overheat and ruin the components. For example, a fan 106 can be provided for this purpose, the fan 106 agitating air, so that the agitated air 107 is blown in the direction of the magnetron 102 and/or the transformer 103. In an example embodiment of the present invention, the microwave generator 100 includes a temperature sensor and further includes a controller that turns the fan 106 on and off depending on a temperature reading of the temperature sensor, for example turning the fan 106 on when the sensed temperature is above a first predefined threshold and turning the fan 106 off when the sensed temperature is below the first predefined threshold or is below a second predefined threshold lower than the first predefined temperature.

In a further example embodiment, the microwave generator 100 includes a temperature limit switch by which the microwave generator 100 is automatically turned off from operating to generate the microwaves 110 when the sensed temperature is above a predefined threshold, e.g., a third predefined threshold that is higher than the first predefined threshold. For example, if the system runs for 15-20 minutes without interruption, this can cause too great a temperature rise, so that the system would need approximately 30-40 seconds of shut-off time to cool down before resuming operation. In an example embodiment, the system resumes operation when it is detected that there has been sufficient cooling. In an alternative example embodiment, the system resumes operation after a predefined amount of shut-off time.

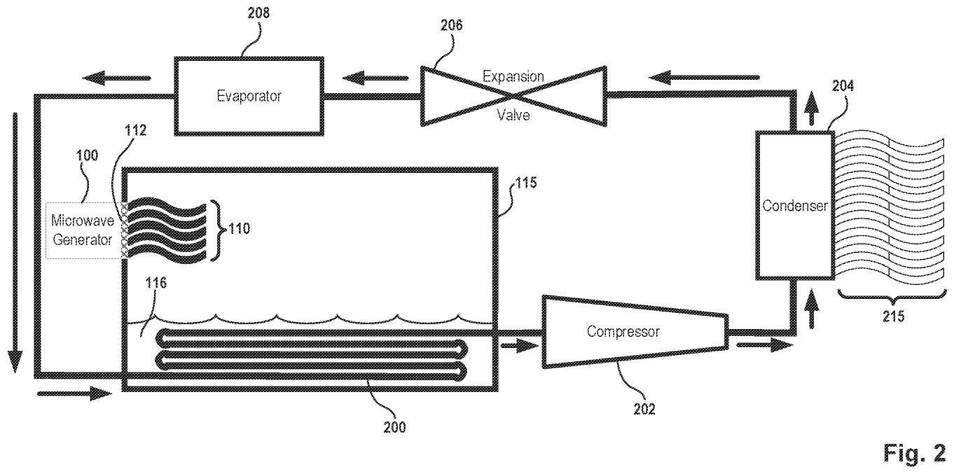

FIG. 2 schematically illustrates an alternative example heating system using a refrigerant. In this regard, the inventor has determined that even more heating efficiency can be achieved by generating heat from a refrigerant heated partially by the medium 116 that is itself heated by the microwaves 110. This embodiment takes advantage of the greater efficiency in raising temperature from a relatively low temperature than in further raising temperature from a higher temperature. For example, raising the temperature from 60° to 120° occurs more efficiently than raising the temperature from 120° to 180° in the case of heating by the microwaves 110. This can be due to the increase in the space between the molecules of the medium 116 that occurs as the temperature of the medium 116 rises, thereby reducing the amount of intermolecular friction and reducing the molecular vibration as the temperature rises, whereas it is the friction and vibration that causes the temperature rise. Therefore, according to this alternative example embodiment, the heated medium 116 is not used directly for the heating of the ambient environment. Instead, the medium 116 is used for an initial heating of a refrigerant, with the initially heated refrigerant then being further heated by compression of the refrigerant into a vapor provided to a condenser for generating hot air from the heated refrigerant, which the compressor blows into the ambient environment.

According to an example embodiment, the refrigerant heating system of FIG. 2 includes a power-up configuration and microwave generator 100 configured to generate microwaves 110 directed with a waveguide, via a film 112, into a reservoir chamber 115 holding therein a medium 116 as described with respect to FIG. 1. However, in contrast to the embodiment described with respect to FIG. 1, the medium 116 is sealed in, and does not flow out of, the reservoir chamber 115. Further, piping, such as metal piping, e.g., of copper, containing therein a refrigerant enters into the reservoir chamber 115 in a direction from an expansion valve 206 and evaporator 208, meanders within the reservoir chamber 115 forming pipe coils 200 within the reservoir chamber 115 and then exits the reservoir chamber 115 in a direction towards a compressor 202. Although the piping is shown as exiting from the reservoir chamber 115 at a different side than at which the piping enters the reservoir chamber 115, in an alternative example embodiment, the entry and exit can be at the same side of the reservoir chamber 115. Arranged between the compressor 202 and the expansion valve 206 is a condenser 204.

In operation, the refrigerant, e.g., R-22 or R-410A, cycles within the illustrated system as shown by the arrows illustrated in FIG. 2. In an example, the refrigerant enters into the reservoir chamber 115 at approximately 20°. Microwaves 110 heat the medium 116. The refrigerant flows within the coils 200 inside the reservoir chamber 115, thereby being heated by the heated medium 116. For example, the coils 200 are submerged within the heated medium 116, thereby warming the refrigerant contained in the coils 200. The refrigerant thereby exits the reservoir chamber 115 in a direction towards the compressor 202, with the refrigerant being at a higher temperature of, for example, approximately 40°-50°. The compressor 202 compresses the refrigerant, thereby further heating the refrigerant, for example, to approximately 200°-250°. The refrigerant then proceeds from the compressor 202 to the condenser 204, where a fan outputs heated air 215 into the ambient environment.

The refrigerant then flows from the condenser 204 to the expansion valve 206 and the evaporator 208, which subject the refrigerant to an expansion that cools the refrigerant back down to the original approximate 20° for cycling back into the reservoir chamber 115.

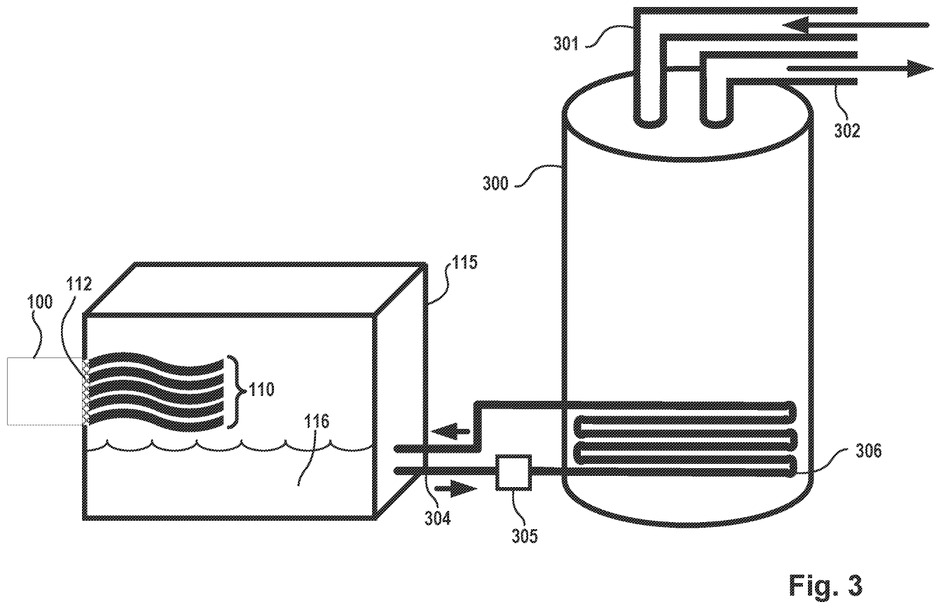

FIG. 3 illustrates an example water heater according to an example embodiment of the present invention. According to an example embodiment, the water heater of FIG. 3 includes a power-up configuration and a microwave generator 100 configured to generate microwaves 110 directed, via a film 112, into a reservoir chamber 115 holding therein a medium 116 as described with respect to FIG. 1. The water heater further includes a water tank 300. The water heater further includes a cold water inlet 301 and a hot water outlet 302. Cold water is filled into the water tank 300 via the cold water inlet 301. After the cold water is then heated as described below, the heated water can be withdrawn from the water tank 300 via the hot water outlet 302.

Piping 304, for example made of metal, e.g., copper, extends from an outlet of the reservoir chamber 115 into the water tank 300, meanders within the water tank 300 to form coils 306, and extends back to inlet into the reservoir chamber 115. A flowing medium flows through piping 304 in the directions shown by the arrows shown in FIG. 3 alongside piping 304. Preferably, the flowing medium is oil.

In operation, the medium 116 is heated by the microwaves 110. The heated medium 116 heats the flowing medium that is within the piping 304, with the piping 304 winding in reservoir chamber 115. A pump 305, which is schematically illustrated in FIG. 3, pumps the flowing medium in piping 304 from the outlet of the reservoir chamber 115 towards the water tank 300. According to this embodiment, the medium 116 is sealed within the reservoir chamber 115 and does not flow into and out of the reservoir chamber 115

In an alternative example embodiment, the piping 304 is not included within, and does not wind within, the reservoir chamber 115. Instead, an inlet into the piping 304 is arranged at a bore of the reservoir chamber 115 forming the outlet of the reservoir chamber 115, and an outlet out of the piping 304 is arranged at a bore of the reservoir chamber 115 forming the inlet of the reservoir chamber 115. According to this embodiment, the medium 116 is not stationary within the reservoir chamber 115. Instead, under influence of the pump 305, the medium 116 circulates by flowing out of the reservoir chamber 115 into the inlet into the piping 304, flows through the coils 306, and then flows back into the reservoir chamber 115 via the outlet from the piping 304.

According to either embodiment, the medium within the coils 306 of the piping 304, whether it is the medium 116 itself or is a different flowing medium that is heated by the medium 116 that has been heated by the microwaves 110, heats the coils 306. The heated coils 306 transfer heat to the water that has entered the water tank 300 via the cold water inlet 301. The heated water can then be drawn out of the water tank 300 via the hot water outlet 302.

What is claimed is:

1. A heating system comprising:
a microwave generator;
a medium reservoir chamber;
a radiator; and
a channel that fluidically connects the medium reservoir chamber and the radiator;
wherein:
the radiator includes hollow fins extending from and in fluidic communication with the channel;
a medium extends as a single fluid body within a combination of the medium reservoir chamber and the channel;
the microwave generator is configured to generate microwaves, and direct the microwaves into the medium reservoir chamber so that the microwaves impinge upon one or more internal surfaces of the medium reservoir chamber, so that the microwaves reflect off of the one or more internal surfaces to thereby impinge upon a portion of the medium that is within the medium reservoir chamber, causing the medium to be heated, the heating of the medium generating a hot vapor in the channel, which rises from the channel into the fins, the fins thereby being heated; and
by the heating of the fins, the fins are configured to radiate heat into an external environment.

2. The heating system of claim 1, wherein the microwave generator includes a magnetron that generates the microwaves.

3. The heating system of claim 2, wherein the microwave generator further includes a transformer and a capacitor arranged to power the magnetron.

4. The heating system of claim 3, wherein the microwave generator further includes a power source from which the transformer draws electrical energy.

5. The heating system of claim 2, wherein the microwave generator further includes a cooling structure arranged to cool the magnetron.

6. The heating system of claim 5, wherein the cooling structure is a fan.

7. The heating system of claim 1, wherein the medium is oil.

8. The heating system of claim 7, wherein the oil is lavender oil.

9. The heating system of claim 1, wherein the medium fills the medium reservoir chamber only until a height point of the medium reservoir chamber that is lower than a region of the medium reservoir chamber at which the microwaves generated by the microwave generator enter the medium reservoir chamber.

10. The heating system of claim 9, wherein a top surface of the medium in the medium reservoir chamber is exposed to a remainder of an interior of the medium reservoir chamber that is above the top surface of the medium in the medium reservoir chamber.

11. The heating system of claim 1, wherein the medium reservoir chamber is horizontally arranged, by which a height of the medium reservoir chamber is less than a length of the medium reservoir chamber, the length being in a direction in which the channel extends across the fins.

12. The heating system of claim 11, wherein the height of the medium reservoir chamber is also less than a width of the medium reservoir chamber.

13. The heating system of claim 1, wherein the medium reservoir chamber is horizontally arranged, by which a height of the medium reservoir chamber is less than a width of the medium reservoir chamber, the width being in a direction that is perpendicular to a direction in which the channel extends across the fins.

14. The heating system of claim 1, further comprising a one-way film that prevents the microwaves that have entered the medium reservoir chamber from the microwave chamber from exiting the medium reservoir chamber in a direction towards the microwave generator.

15. A heating system comprising:
a microwave generator;
a medium reservoir chamber;
a piping system that extends into and out of the medium reservoir chamber and a part of which winds within the medium reservoir chamber, thereby forming coils within the medium reservoir chamber; and
a hot air blower;
wherein, during operation of the heating system:
the microwave generator is configured to generate microwaves and direct the microwaves into the medium reservoir chamber so that the microwaves heat a medium stored in the medium reservoir chamber;
a refrigerant flows within the piping, entering, within the piping, at a first temperature into an interior of the medium reservoir chamber;
after entering into the medium reservoir chamber, the refrigerant is heated by the heated medium to a second temperature that is higher than the first temperature, while the refrigerant is in the coils; and
the refrigerant, which has been heated from the first temperature to the second temperature, is directed via the piping from the medium reservoir chamber towards a hot air blower that outputs hot air into an environment external to the heating system using the heating of the refrigerant.

16. The heating system of claim 15, further comprising at least one of an expansion valve and an evaporator via which the heated refrigerant is cooled down to the first temperature, wherein, during the operation of the heating system, the refrigerant flows within the piping from the at least one of the expansion valve and the evaporator into the medium reservoir chamber.

17. The heating system of claim 16, further comprising a compressor arranged between the medium reservoir chamber and the hot air blower, wherein, during the operation of the heating system, the compressor is configured to further heat the refrigerant exiting from the medium reservoir chamber at the second temperature to a third temperature that is higher than the second temperature, wherein the hot air blower is configured to use the refrigerant at the third temperature to blow the hot air.

18. The heating system of claim 17, wherein the hot air blower is a condenser.

19. A water heating system comprising:
a water tank;
a cold water inlet;
a hot water outlet;
a medium reservoir chamber;
a microwave generator;
a piping system that extends from the medium reservoir chamber into the water tank, winds within the water tank thereby forming coils within the water tank, and further extends from the water tank back to the medium reservoir chamber; and
a flow pump;
wherein, during operation of the heating system:
the microwave generator is configured to generate microwaves directed into the medium reservoir chamber by which a medium within the piping is heated;
the flow pump is configured to cause the heated medium to flow from the medium reservoir chamber into the coils, the medium cycling back from the coils to the medium reservoir chamber;
the flow of the heated medium into the coils heats the coils, by which the coils transfer heat to cold water that has been input into the water tank via the cold water inlet; and
the water that has been heated by the coils can be drawn from the water tank via the hot water outlet.

20. The water heating system of claim 19, wherein the medium in the piping is oil, and the heating of the medium occurs due to:
impingement of the microwaves upon a portion of the medium that is exposed to the microwaves in the medium reservoir chamber; or
impingement of the microwaves upon another medium sealed within the medium reservoir chamber, thereby heating the other medium, the heated other medium thereby heating a portion of the medium in the piping that is within a section of the piping that is within the medium reservoir chamber.
